(19) United States
(12) Patent Application Publication
(10) Pub. No.: US 2025/0203601 A1
(43) Pub. Date: Jun. 19, 2025

(54) 5G SCHEDULING USING TIME SENSITIVE NETWORK INFORMATION

(71) Applicant: General Electric Company, Schenectady, NY (US)

(72) Inventor: Stephen F. BUSH, Niskayuna, NY (US)

(21) Appl. No.: 18/845,601

(22) PCT Filed: Mar. 10, 2023
(86) PCT No.: PCT/US2023/064093

§ 371 Date: Sep. 10, 2024

Related U.S. Application Data
(60) Provisional application No. 63/318,896, filed on Mar. 11, 2022.
(60) Provisional application No. 63/318,431, filed on Mar. 10, 2022.

(51) Int. Cl. H04W 72/12; H04W 56/00; H04W 92/02

(52) U.S. Cl. CPC H04W 72/1215; H04W 56/002; H04W 92/02

(57) ABSTRACT

Techniques disclosed in the present disclosure relate to communication networks and methods for supporting time-sensitive deterministic communication based on a time-sensitive network (TSN) mechanism. A communication network may include a plurality of network domains in the communication network connecting each other, and a plurality of schedulers in the plurality of network domains. A respective of the plurality of schedulers may compute a local schedule for a respective of the plurality of network domains, and a first scheduler and a second scheduler of the plurality of schedulers may iteratively exchange a first local schedule and a second local schedule. The first local schedule and the second local schedule may include different cycle times. The first network domain may transmit interdomain ethernet link information related to a link connecting the first network domain and the second network domain, and intradomain schedule information related to the first local schedule.

### PRIORITY

This application claims priority to U.S. Provisional Patent Applications 63/318,431 filed Mar. 10, 2022 and 63/318,896 filed Mar. 11, 2022, both of which are hereby incorporated by reference in their entirety.

### TECHNICAL FIELD

The present description relates generally to integration of a wireless communication system and a time-sensitive network (TSN), and, more particularly, for example, to integrating the scheduling of a TSN with the scheduling of a 5G system to improve the scheduling of both systems via distributed scheduling.

### BACKGROUND

Media Access Control (MAC) is a sublayer of the data link layer of a telecommunications network, in accordance with the Open Systems Interconnection (OSI) model. The data link layer is layer 2 of the seven-layer framework. Together with local link control (LLC), MAC provides flow control and multiplexing for the transmission medium. In cellular networks such as a 5G system (5GS) and its predecessors, MAC is designed to maximize the utilization of over the air spectrum. A 5GS attempts to provide media access control using a combination of separation in time and frequency.

Some applications such as industrial automation and manufacturing require ubiquitous and seamless connectivity with strict, deterministic timing requirements for communications between various devices or components (e.g., an industrial controller, a sensor, an actuator, etc.) of the application. To meet such requirements, a TSN system provides deterministic communication with relatively stringent quality of service (QOS) parameters, such as latency, jitter and reliability requirements for data traffic. Time-sensitive networking (TSN) was originally created because traditional Ethernet networks did not deliver packets with any concept of time. Traditional Ethernet networks delivered packets with a “best effort” framework, but there were no absolute deadlines for when a file had to be transferred from one location to another, for example. The file had to get to its destination, in its compete form, as soon as possible but not at any particular time. Certain use cases, such as audio, video and diagnostic communications, required time deadlines, resulting in the creation of the concept of TSN. TSN scheduling uses only separation in time. Time is synchronized across nodes in a TSN network, which creates a schedule for frames to be sent to destinations via a node path, that is chosen based on the knowledge regarding whether that node is busy at that particular time.

Given the growing popularity of 5G wireless communication system, TSN systems may be integrated with a 5G system, which provides a high reliability service, such as an ultra-reliable low latency communication (URLLC) service. Because both the TSN system and the 5G system both have schedulers, information from the TSN scheduler could be incorporated into the 5G scheduler to improve the scheduling it performs.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates an example of a conventional integrated TSN-5G system 100 in accordance with one or more implementations.

FIG. 2 illustrates a block diagram of an example integrated TSN-5G system 200 architecture in accordance with one or more implementations.

FIG. 3 illustrates an electronic system with which one or more implementations of the subject technology may be implemented.

FIG. 4 illustrates a block diagram of an example integrated TSN-5G system 800 architecture in accordance with one or more implementations.

FIGS. 5A and 5B illustrate block diagrams of the inputs and outputs of TSN and 5G schedulers in accordance with one or more implementations.

FIG. 6 illustrates a block diagram of a TSN network including a scheduler in accordance with one or more implementations.

FIG. 7 is a flow chart of a distributed scheduling algorithm in accordance with one aspect of the present disclosure.

FIG. 8 is a block diagram of distributed scheduling in multiple domains in accordance with one aspect of the present disclosure.

FIG. 9 is a block diagram of a distributed scheduler message in accordance with one aspect of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As noted above, for some applications such as, but not limited to, industrial automation, manufacturing, and aerospace and automotive in-vehicle communications, a TSN system, which provides deterministic communication, may be integrated with a fifth-generation (5G) wireless communication system, which provides flexibility and an ultra-reliable low latency communication (URLLC) service.

As noted above, TSN was created to fill a need, in traditional Ethernet networks, for frames to be delivered with a maximum allowable latency from when they were sent. In other words, to be delivered by a particular time. While traditional ethernet networks did not have a time domain, 5GS does have a time domain, and also creates a schedule for delivery of frames, that does have a timed element. Accordingly, if the TSN scheduler was able to have knowledge of the state of the 5G scheduler, it could generate better schedules. If the TSN application scheduler could be informed of the state of the 5G scheduler Resource Blocks, it could add appropriate constraints to guide its solution. On the other hand, if 5G schedulers know that traffic is from a TSN system and will therefore be periodic, it can make more informed scheduling decisions.

A TSN leverages the IEEE 802.1Qbv standard, which requires a scheduler to compute when Ethernet frames, for a specific flow, are to be transmitted at each hop along their path from source to destination, without colliding with other TSN scheduled Ethernet frames. TSN frames may flow through a 5G System (5GS) that may include a 5G base station (gNB, also known as gNodeB) using 5g New Radio (NR) technology. NR and gNB also require a scheduler to determine when and with what resources to transmit data passing through the radio. Accordingly, it would be advantageous to enable a joint TSN/5G scheduling operation. However, typically, in such an integrated TSN-5G system, the entire 5G system is configured to operate as one single TSN component (e.g., a TSN bridge), and the integrated system is set up as a fully centralized configuration model, e.g., that uses one centralized TSN configuration controller. Accordingly, such an integrated system may not support flexibility of deploying a 5G system that includes various components provided by different vendors or for a decentralized TSN configuration of the integrated system. Further, a 5G system may support reliable communication by using redundant paths for data transmission. However, with the 5G system being set up as one TSN component in a typical TSN-5G integrated system, the redundant paths are configured across the entire 5G system through all its components (e.g., from user equipment (UE) to user plane function (UPF)). This does not allow for flexibility of setting up redundant data transmission paths for only for a portion of the 5G system, e.g., the 5G system portion (such as an air interface between UE and radio access network (RAN)/gNodeB) that is more susceptible to data delay and/or errors.

To address the above-discussed issues in an integrated TSN-5G system, the subject technology provides for a novel method of joint scheduling, leveraging the predictability of the TSN Qbv schedule, which includes precise, non-overlapping transmission times that enable the 5GS to predict when TSN data from specific flows will arrive at the radio and the maximum size of the messages. Knowledge of information known by the TSN scheduler, including arrival time and message size, can enable the gNB scheduler to better allocate resource elements (RE) and resource blocks (RB). Knowledge of TSN scheduling information could also play a role in optimizing multiple-input/multiple-out (MIMO) antenna operation, which is at lower physical level than the gNB scheduler.

Joint TSN-5G scheduling may be achieved, in one aspect of the present disclosure, via distributed scheduling. Accordingly, the present disclosure relates to a 5G bi-directional scheduling status information message. The message may contain anticipated TSN User Equipment (UE) configuration from the TSN application scheduler and may return 5G scheduler information such as that found in the System Information Block (SIB) scheduling information. More information about SIB scheduling information may be found in 3GPP TS 38.331 version 15.5.1 Release 15 (“5G, NR, Radio Resource Control (RRC), Protocol specification”), which is incorporated herein by reference in its entirety.

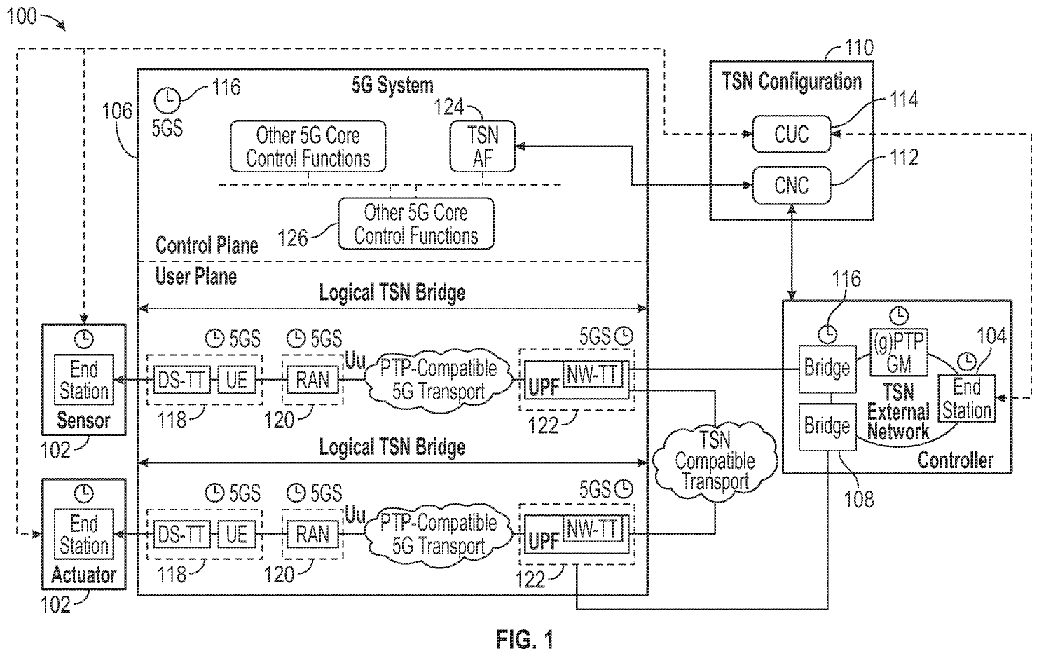

FIG. 1 illustrates a non-limiting example of a conventional integrated TSN-5G system 100 in which a 5G system 106 is configured to be emulated as a single TSN component (e.g., a TSN bridge). Overall, the system 100 is configured as a deterministic TSN system to communicate data between end-devices, e.g., input/output (I/O) devices 102 and a controller 104, via the 5G system 106 (emulating as a TSN bridge) and one or more (conventional) TSN bridges 108 and using a TSN controller 110. The system 100 is configured based on standard methods for time synchronization and traffic management, allowing deterministic communication over standard Ethernet networks between end-devices, e.g., the I/O devices 102 and the controller 104. For example, the system 100 may operate in accordance with the IEEE 802.1Q TSN specification suite, which standardizes layer-2 communication for networking protocols providing deterministic communication while sharing the same infrastructure. For example, a number of standards establish various technological paradigms for a TSN system-clock synchronization (802.1AS, generalized Precision Time Protocol (gPTP)), frame preemption (802.3br and 802.1Qbu), scheduled traffic (802.1Qbv), and redundancy management (Frame Replication and Elimination for Reliability (FRER) IEEE 802.1CB). These standards must work together at the Ethernet layer-2 to ensure that critical control and safety functions are executed while meeting their respective deadlines and constraints. As another implementation, similar integrated system may be configured to implement TSN techniques over a wireless local area network (wireless LAN) such as a Wi-Fi network, e.g., based on Wi-Fi 6 and other common wireless LANs.

As used herein, “TSN schema” can refer, without limitation, to networks, components, elements, units, nodes, hubs, switches, controls, modules, pathways, data, data frames, traffic, protocols, operations, transmissions, and combinations thereof, that adhere to, are configured for, or are compliant with, one or more of IEEE 802.1 TSN standards. The 802.1Qbv TSN standard addresses the transmission of critical and non-critical data traffic within a TSN. Critical data traffic is guaranteed for delivery at a scheduled time while non-critical data traffic is usually given lower priority. Various traffic classes have been established according to IEEE 802.1Q that are used to prioritize different types of data traffic.

Ethernet frame preemption is defined by the IEEE 802.3br and IEEE 802.1Qbu standards, which can suspend the transmission of a non-critical Ethernet frame, is also beneficial to decrease latency and latency variation of critical traffic. Resource management basics are defined by the TSN configuration models (IEEE 802.1Qcc). Centralized Network Configuration (CNC) 112 can be applied to the network devices (bridges, e.g., the 5G system bridge 106, bridges 108), whereas, Centralized User Configuration (CUC) 114 can be applied to user devices (end stations, e.g., the I/O devices 102). The fully centralized configuration model follows a software-defined networking (SDN) approach. In other words, the CNC 112 and the CUC 114 in the controller 110 provide the control plane instead of distributed protocols. In contrast, distributed control protocols are applied in the fully distributed model, where there is no CNC or CUC.

High availability, as a result of ultra-reliability, may be provided by Frame Replication and Elimination for Reliability (FRER) (IEEE 802.1CB) for data flows through a per-packet-level reliability mechanism. This provides reliability by transmitting multiple copies of the same data packets over disjoint paths in the network. Per-Stream Filtering and Policing (802.1Qci) improves reliability by protecting against bandwidth violation, malfunctioning and malicious behavior. Further, the time synchronization in the TSN system may be defined by the generalized Precision Time Protocol (gPTP) (802.1AS), which is a profile of the Precision Time Protocol standard (IEEE 1588). The gPTP provides reliable time synchronization, which can be used by other TSN tools, such as Scheduled Traffic (802.1Qbv).

To achieve desired levels of reliability, TSNs employ time synchronization, and time-aware data traffic shaping. The data traffic shaping uses the schedule to control gating of transmissions on the network switches and bridges (e.g., nodes). In some aspects, the schedules for such data traffic in TSNs can be determined prior to operation of the network. In other aspects, the schedules for data traffic can be determined during an initial design phase based on system requirements, and updated as desired. For example, in addition to defining a TSN topology (including communication paths, bandwidth reservations, and various other parameters), a networkwide synchronized time for data transmission can be predefined. Such a plan for data transmission on communication paths of the network is typically referred to as a “communication schedule” or simply “schedule.” The schedule for data traffic on a TSN can be determined for a specific data packet over a specific path, at a specific time, for a specific duration. A non-limiting example of a technique for generating a schedule for TSN data traffic is discussed in U.S. application Ser. No. 17/100,356, which is incorporated herein in its entirety by reference.

Time-critical communication between end devices or nodes (e.g., the I/O devices 102 and the controller 104) in TSNs includes “TSN flows” also known as “data flows” or simply, “flows.” For example, data flows can comprise datagrams, such as data packets or data frames. Each data flow is unidirectional, going from a first originating or source end device (e.g., the I/O device 102) to a second destination end device (e.g., the controller 104) in a system, having a unique identification and time requirement. These source devices and destination devices are commonly referred to as “talkers” and “listeners.” Specifically, the “talkers” and “listeners” are the sources and destinations, respectively, of the data flows, and each data flow is uniquely identified by the end devices operating in the system. It will be understood that for a given network topology comprising a plurality of interconnected devices, a set of data flows between the inter-connected devices or nodes can be defined. For example, the set of data flows can be between the interconnected devices. For the set of data flows, various subsets or permutations of the dataflows can additionally be defined. Further, time-critical communication between end devices or nodes in TSNs includes “TSN streams” or “streams,” where each TSN stream may originate at a specific talker node intended to be communicated to one or more listener nodes. As such, each TSN stream may include one or more data flows, where each data flow is between the talker node (where the TSN stream originated) and a listener node.

Both end devices (e.g., 102, 104) and switches (commonly called “bridges” or “switching nodes”) (e.g., 106, 108) transmit and receive the data (in one non-limiting example, Ethernet frames) in a data flow based on a predetermined time schedule. The switching nodes and end devices must be time-synchronized to ensure the predetermined time schedule for the data flow is followed correctly throughout the network. For example, in FIG. 1, the clocks 116 represent that the various switching nodes and end devices in the TSN system 100 (including in the 5G system 106) are be time-synchronized with reference to a global clock (grandmaster clock timing). In some other aspects, only the switches can transmit the data based on the predetermined schedule, while the end devices, for example legacy devices, can transmit data in an unscheduled manner.

The data flows within a TSN can be scheduled using a single device (e.g., the controller 110) that assumes fixed, non-changing paths through the network between the talker/listener devices and switching nodes in the network. Alternatively, the data flows can be scheduled using a set of devices or modules. The scheduling devices, whether a single device or a set of devices, can be arranged to define a centralized scheduler. In still other aspects, the scheduler devices can comprise a distributed arrangement. The TSN can also receive non-time sensitive communications, such as rate-constrained communications. In one non-limiting example, the scheduling devices can include an offline scheduling system or module.

TSN traffic may be tagged using a variety of mechanisms, including VLAN tag Ethernet address IP header information, and a combination of VLAN tag Ethernet address and IP header information. Traffic may be identified and tagged anywhere in the system before protocol data unit (PDU) identification is required. A TSN Talker may create multiple TSN flows (streams) with different TSN latency and determinism requirements and may be assigned different paths that meet the requirements. In some implementations of the subject invention, the latency and determinism values may be specified and offered to TSN applications as a limited set of static, discrete values, rather than an offering to accept an unlimited set of continuous values.

In some implementations, the I/O end device 102 may be, in various aspects, a complex mechanical entity such as the production line of a factory, a gas-fired electrical generating plant, avionics data bus on an aircraft, a jet engine on an aircraft amongst a fleet (e.g., two or more aircraft), a digital backbone in an aircraft, an avionics system, mission or flight network, a wind farm, a locomotive, etc. In various implementations, the I/O end device 102 may include any number of end devices, such as sensors, actuators, motors, and software applications. The sensors may include any conventional sensor or transducer, such as a camera that generates video or image data, an x-ray detector, an acoustic pick-up device, a tachometer, a global positioning system receiver, a wireless device that transmits a wireless signal and detects reflections of the wireless signal in order to generate image data, or another device.

Further, the actuators (e.g., devices, equipment, or machinery that move to perform one or more operations of the I/O device 102) can communicate using the TSN system 100. Non-limiting examples of the actuators may include brakes, throttles, robotic devices, medical imaging devices, lights, turbines, etc. The actuators can communicate status data of the actuators to one or more other devices (e.g., other I/O devices 102, the controller 104 via the TSN system 100). The status data may represent a position, state, health, or the like, of the actuator sending the status data. The actuators may receive command data from one or more other devices (e.g., other I/O devices 102, the controller 104) of the TSN system 100. The command data may represent instructions that direct the actuators how or when to move, operate, etc.

In some implementations, the controller 104 can communicate a variety of data between or among the I/O end devices 102 via the TSN 100. For example, the control system 104 can communicate the command data to one or more of the devices 102 or receive data, such as status data or sensor data, from one or more of the devices 102. Accordingly, the controller 104 may be configured to control operations of the I/O devices 102 based on data obtained or generated by, or communicated among the I/O devices 102 to allow for, e.g., automated control of the I/O devices 102 and provide information to operators or users of the I/O devices 102. The controller 104 may define or determine the data flows and data flow characteristics in the TSN system 100.

Referring now to the 5G system 106 within the system 100, the 5G system 106 is a wireless communication system used to carry TSN traffic between various TSN end devices, e.g., the I/O devices 102 and the controller 104. In some implementations, the 5G system 106 is configured to emulate as one TSN bridge per User Plane Function (UPF) (similar to TSN bridges 108, according to the TSN standards discussed above). The 5G system 106 may be a New Radio (NR) network implemented in accordance with 3GPP 23 and 38 series specifications (which are incorporated herein in their entirety), and integrated into the system 100 in accordance with the 3GPP Release 17 23.501 standard v17.1.1 and v17.2.0 (which are incorporated herein in entirety). As shown, the 5G system 106 may include, in the 5G user plane, User Equipment (UE) 118, RAN (gNB) 120, User Plane Function (UPF) 122, and in the 5G control plane, application function (AF) 124 and policy control function (PCF) 126, among other components. In some implementations, the 5G system 106 may be configured to provide an ultra-reliable low latency communication (URLLC) service. The 5G system 106 based on the New Radio (NR) interface includes several functionalities to achieve low latency for selected data flows. NR enables shorter slots in a radio subframe, which benefits low-latency applications. NR also introduces mini-slots, where prioritized transmissions can be started without waiting for slot boundaries, further reducing latency. As part of giving priority and faster radio access to URLLC traffic, NR introduces preemption—where URLLC data transmission can preempt ongoing non-URLLC transmissions. Additionally, NR applies very fast processing, enabling retransmissions even within short latency bounds.

In some implementations, 5G defines extra-robust transmission modes for increased reliability for both data and control radio channels. Reliability is further improved by various techniques, such as multi-antenna transmission based on multiple-input and multiple-output (MIMO) techniques, the use of multiple carriers and packet duplication over independent radio links.

Time synchronization is embedded into the 5G cellular radio systems as an essential part of their operation, which has already been common practice for earlier cellular network generations. The radio network components themselves are also time synchronized, for instance, through the precision time protocol telecom profile. This provides a good basis to provide synchronization for time-critical applications. For URLLC service, the 5G system 106 uses time synchronization for its own operations, as well as the multiple antennas and radio channels that provide reliability. Besides the 5G RAN features, the 5G system 106 may also provide solutions in the core network (CN) for Ethernet networking and URLLC. The 5G CN supports native Ethernet protocol data unit (PDU) sessions. 5G assists the establishment of redundant user plane paths through the 5GS, including RAN, the CN and the transport network. The 5GS also allows for a redundant user plane separately between the RAN and CN nodes, as well as between the UE and the RAN nodes.

As noted above, in the integrated system 100, the 5G system 106 one TSN (virtual) bridge per UPF. The 5G system 106 includes TSN Translator (TT) functionality for the adaptation of the 5G system 106 to the TSN domain, both for the user plane and the control plane, hiding the 5G system 106's internal procedures from the TSN bridged network. The 5G system 106 provides TSN bridge ingress and egress port operations through the TT functionality. For instance, the TTs support hold and forward functionality for de-jittering. FIG. 1 illustrates the case when the 5G system 106 connects an end station 102 to a bridged network 108; however, the 5G system 106 may also interconnect bridges 108.

For the 5G system 106 to be integrated into the TSN system 100, requirements of a TSN stream can be fulfilled only when resource management allocates the network resources for each hop along the whole path. In line with TSN configuration (802.1Qcc), this is achieved through interactions between the 5G system 106 and the CNC 112. The interface between the 5G system 106 and the CNC allows for the CNC 112 to learn the characteristics of the 5G virtual bridge, and for the 5G system 106 to establish connections with specific parameters based on the information received from the CNC 112. Bounded latency requires deterministic delay from 5G as well as QoS alignment between the TSN and 5G domains. For instance, if a 5G virtual bridge acts as a TSN bridge, then the 5G system 106 emulates time-controlled packet transmission in line with Scheduled Traffic (802.1Qbv). For the 5G control plane, the TT in the AF 124 receives the transmission time information of the TSN traffic classes from the CNC 112. In the 5G user plane, the TT at the UE 118 and the TT at the UPF 122 may regulate the time-based packet transmission accordingly. The different TSN traffic classes may be mapped to different 5G QoS Indicators (5QIs) in the AF 124 and the PCF 126 as part of the QoS alignment between the TSN and 5G domains, and the different 5QIs are treated according to their QoS requirements.

With respect to time synchronization, the 5G system 106 may implement the gPTP of the connected TSN network. The 5G system 106 may act as a virtual gPTP time-aware system and support the forwarding of gPTP time synchronization information between end stations 102 and bridges 108 through the 5G user plane TTs.

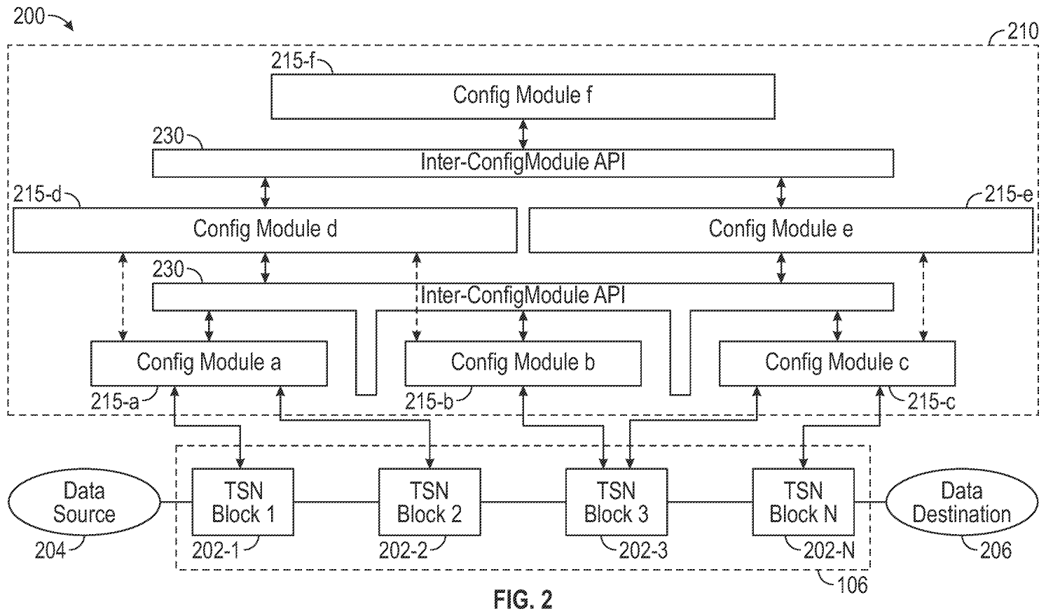

Referring now to FIG. 2, which illustrates a block diagram of a system 200 architecture in accordance with some implementations of the subject technology. Broadly, the system 200 may be implemented as an integrated TSN-5G system similar to the system 100 described above, and also include similar physical components as in the system 100 discussed above. However, unlike the system 100, the system 200 provides a novel architecture for an integrated TSN-5G system in which the 5G system 106 is configured as a set of discrete 5G components where each 5G component is configured to emulate as one discrete TSN block 202. In other words, in the system 200, the 5G system 106 is configured as a disaggregated structure including a plurality of TSN blocks 202-1 to 202-N, where each TSN block 202 is configured in accordance with TSN specifications (e.g., per IEEE 802.1 and related standards discussed above), e.g., as a TSN bridge, TSN end device, or a combination of two. Further, instead of having a centralized configuration controller 110 to control the TSN-5G system, the subject technology provides for a plurality of distributed configuration modules 215 in a distributed controller 210 in the TSN-5G system 200. The configuration modules 215-a to 215-f may be interconnected in one or more topologies (mesh, star, tree) and each configuration module 215 may be responsible to communicate with and configure one or more TSN blocks 202. As used herein, a “topology” can refer to one or more arrangement(s) of a network which can include a plurality of nodes (e.g., sender devices, receiver devices, switches, or bridges) and connecting lines (e.g., communication links, or “hops” including wired communication links or wire-less communication links) between the nodes in the network. Each link can communicatively couple a corresponding pair of nodes. A set of links can be coupled in sequence via their respective nodes to define a link path, for example between an originating node and a destination node. Topologies may comprise, but are not limited to, one or more of mesh, star, bus, ring, and tree topologies.

In some implementations, the system 200 is configured to support and manage deterministic TSN data flows between a data source 204 and a data destination 206 via the 5G system 106 in accordance with TSN configuration including a TSN schedule determined by one or more of the configuration modules 215. The data source 204 and the data destination 206 may include one or more of the I/O devices 102 and the controller 104. Although not shown, the system 200 may also include TSN bridges 108 and other TSN components.

In some implementations, in the disaggregated structure, each of the plurality of TSN blocks 202-1 to 202-N may correspond to one specific component of the 5G system, e.g., the 5G system 106 shown in FIG. 1 and discussed above. For example, the UE 118 may be configured to emulate as the TSN block 202-1, the RAN 120 may be configured to emulate as the TSN block 202-2, the UPF 122 may be configured to emulate as the TSN block 202-3, and the core network and/or other typical components of a 5G system (e.g., fronthaul, backhaul, Multi-access Edge Computing (MEC) module) may be configured to emulate as one or more TSN blocks 202-N. Each TSN block 202-1 to 202-N is configured in accordance with TSN specifications (e.g., per IEEE 802.1 and related standards discussed above), e.g., as a TSN bridge, TSN end device, or a combination of two.

In some implementation, a memory device of a TSN block 202 may store a set of parameters describing the capabilities to support and execute a data flow (e.g., carrying URLLC data traffic) through the corresponding TSN block 202. In some implementations, the set of parameters include, but are not limited to, identity, link quality, link bandwidth. The identity parameter(s) may include the device type (i.e., whether the TSN block 202 is a TSN bridge or a TSN end station). The latency parameter(s) may include at least port-to-port (start of TSN block to end of TSN block) latency, and latency variation (commonly known as “jitter”). The link quality parameter(s) may include at least packet error rate. The link bandwidth parameter(s) may include at least the available bandwidth in bits per second.

In some implementations, the set of parameters for a TSN block 202 may include a subset of parameters specific to 5G RAN including short transmission-time intervals, TSC assistance information (TSCAI), configured grant (CG) information, semi-persistent scheduling (SPS) allocation and/or other parameters as specified in, e.g., 3GPP TS 28.540. Further, in some implementations, the set of parameters for a TSN block 202 may include a subset of parameters specific to TSN including time synchronization properties, scheduled transmissions (Qbv) attributes, redundancy attributes including a number of RANs connected to, number of paths to UPF, path diversity, number of available frequencies, propagation characteristics, available radios, different physical media (e.g., free space optics).

In some implementations, the set of parameters for a TSN block 202 may define a worst case time synchronization error, a worst case gate operation error, a maximum gate control list size, a maximum cycle time, a maximum gate interval duration, a transmission start delay, the like, or a combination thereof. The set of parameters may include a discrete set of deterministic parameters that may vary by the type of traffic handled by the TSN block 202. The set of parameters may be at least partially utilized to generate a TSN Schedule, configuration, or the like, that is realizable on the hardware of the TSN block 202. In the absence of such set of parameters, a TSN scheduling module has to take a lowest common denominator approach, wherein all devices of the system 200 including TSN blocks 202 are assumed to have the most limiting characteristics resulting in a sub-optimal solution. In this sense, the set of parameters enable better scheduling solution in the TSN system 200 resulting in improved performance metrics including latency, jitter, packet delay variation, and bandwidth utilization.

Referring back to FIG. 2, the subject technology provides for a plurality of distributed configuration modules 215 in a distributed controller 210 in the TSN-5G system 200. The configuration modules 215-a to 215-f may be interconnected in one or more topologies (mesh, star, tree) and each configuration module (CM) 215 may be responsible to communicate with and configure one or more TSN blocks 202. For example, the CM 215-a may be responsible for and operatively and communicatively connected to the TSN blocks 202-1 and 202-2. The CM 215-b may be responsible for and operatively and communicatively connected to the TSN blocks 202-3. The CM 215-c may be responsible for and operatively and communicatively connected to the TSN blocks 202-3 and 202-N. As such, the TSN block 202-3 may be configured and controlled by both the CM 215-b and the CM 215-c. For example, a portion of functionalities (e.g., with respect to a first type of TSN applications) at the TSN block 202-3 may be configured and controlled by the CM 215-b, and another portion of functionalities (e.g., with respect to a second type of TSN applications) at the TSN block 202-3 may be configured and controlled by the CM 215-c.

In the example shown in FIG. 2, the configuration modules 215 are arranged in a tree structure where the CM 215-f forms the highest level of the tree structure, the CM 215-a, 215-b, and 215-c form the lowest level of the tree structure, and the CM 215-d and 215-e are between the highest and lowest levels of the tree structure. The configuration modules 215, however, are operatively and communicatively connected to each other via an API 230. In some implementations, in a tree structure (e.g., as shown in FIG. 2), the configuration modules 215 may communicate with other configuration modules 215 at an adjacent tree level (one tree level higher or lower). However, in other topologies (e.g., in a mesh or peer-to-peer structure), any two configuration modules 215 in a distributed controller 210 may be operatively connected to and communicate with each other directly.

In some implementations, each configuration module 215 may be either an external utility responsible for configuring one or more corresponding TSN blocks 202 or may be configured as a software module within the TSN block 202. Each configuration module 215 may be configured to determine and provide to TSN blocks 202 controlled by the configuration module 215 configuration data including a TSN schedule for one or more data flows to be transmitted through the TSN blocks 202. The configuration modules 215 may exchange information with each other using a standardized API 230. The exchanged information may include information regarding cycles times for the TSN system (e.g., supported admin cycle times (ACTs) including discrete levels of ACT buckets each corresponding to a specific data flow, max/min cycle times), configuration data including transmission schedule (include time offsets/duration/resources for transmission) for one or more TSN blocks 202, and information to request or respond to requests for resource allocations. In some implementations, one or more of the configuration modules 215 may be configured as the CNC 112 and/or the CUC 114 of the TSN controller 110 discussed above.

In some implementations, each configuration module (CM) 215 receives from the ICI 406 of the TSN block 202 controlled by the CM 215 some or all of the set of parameters (discussed above) of the TSN block 202. The CM 215 also receives, from another entity in the system 200 through the API 230, information on the data flows to be configured through the TSN block 202. In a non-limiting example, the data source 204 and/or the data destination 206 provide requirements for a data flow between the data source 204 and the data destination 206 to the CM 215 either directly or via an intermediary such as a CUC 114. In some implementations, the CM itself may allow users to define the set of data flows to be configured via a user interface. As used herein, the information on the data flows may include or define a set of data flows, data streams, transmission pathways (predetermined or otherwise adapted), or the like, to define the desired TSN communication pathways between the data source 202 and the data destination 206. A set of non-limiting examples of the information on the data flows may include a maximum allowable latencies, data rate, data frame sizes (“payload”), data frame destinations, band allocation gaps, the like, or a combination thereof.

Based at least on the received data flow information and the set of parameters for the TSN block 202, the CM 215 determines a “solution” (or configuration data), wherein the solution would indicate how to handle each data flow through the TSN block 202. This solution may include time aware schedule, policing rules, amongst other things, as discussed in U.S. application Ser. No. 17/100,356, which is incorporated herein in its entirety by reference. The CM 215 may then send this solution or configuration data to the TSN block 202 via the ICI 406. The TSN block 202 may then executes this solution and transmits data for each flow according to its configuration. In some implementations, as an example process to make the distributed CMs 215 compute a solution, at each level of the tree structure of the CMs 215, a same system modulo theory (SMT) solver may be used, wherein the data flows and their requirements are expressed as constraints and a linear programming methodology is used to solve for a feasible solution. The solution from a lower level of the CM tree is input as used resources (represented again by constraints) at the one-level higher on the CM tree. This process is repeated until the top-most level of the CM tree is reached, where a global solution is determined.

In some implementations, different data sources (e.g., the data source 204) and their applications operate at different cycle times or intervals. Relatedly, different data sources and destinations (and their applications) require different levels of time determinism for many data flows therebetween. In a conventional TSN system, a converged cycle time (commonly known as “admin cycle time”) is determined that works for all the data flows in the network. However, in some implementations of the subject disclosure, the integrated TSN-5G system may use a set of discrete/quantized cycle times in the network. Each data flow chooses one of the available quantized cycle times to operate on. The scheduling in the TSN-5G system 100 for scheduled transmissions may be based on quantized/discrete set of cycle times. As an example, the integrated TSN-5G system 100 may limit the available stream intervals and therefore the corresponding cycle times to a set of discrete values including, but not limited to, essentially 1, 10, 100, 1000 milliseconds. Similarly, the stream or data flow requirements may be restricted, e.g., jitter (packet delay variation) requirements could be limited to a predetermined set of discrete values including, but not limited to, essentially 1, 10, 100, 1000 microseconds. In some implementation, a different set of discrete values may be used depending on the applications and use cases supported by the integrated TSN-5G system. For example, geographically dispersed system may use discrete cycles times in the order of milliseconds. In yet another example, a system restricted to a local factory may use discrete cycle times in the order of microseconds. The members of this discrete set may be regularly or irregularly spaced or follow other statistical distribution (including but not limited to logarithmic, linear, gaussian) without defaulting to continuous set of cycle times. In another implementation, set of cycle times are standardized in such a manner that all TSN blocks have cycle times that are a product of elements chosen from a small, common set of prime numbers. This ensures that all composite cycle times will be easily computed by the TSN scheduler and results in one common network cycle time.

Each TSN block in the integrated TSN-5G system may support a set (wherein a set includes one or more) of cycle times. The CMs 215 configure the TSN-5G system 106 or 200 to enable scheduled transmission of data flows across TSN blocks 202 operating at different cycle times. In some implementations, the TSN blocks 202 may be required to operate with compatible cycle times, where compatibility implies the cycle times are an integer harmonic of each other. When an application requests an interval that does not directly map to the available set of discrete cycle times across the set of TSN blocks 202 the flow traverses, the CMs 215 may fit to the closest available cycle time. The closest available cycle time would be an integer multiple or integer divisor of the available cycle times. The CMs 215 may exchange the supported quantized/discrete set of cycle time information with each other during the configuration process. In this instance, the subject disclosure allows a disaggregated TSN-5G system to create feasible configuration for a large number of data streams/flows. In the absence of a quantized cycle/interval, the configuration typically requires large computation time and may even prevent the discovery of a feasible solution.

In some instances, each integrated TSN-5G network slice in the 5G system 106 may have a predefined set of supported cycle times and jitter bounds. In some instances, network slices might be more granular than the typical 5G network slice as per 3GPP specification 23.501, which is incorporated herein by reference. In some implementations, the TSN-5G system 106 or 200 may be sliced based on the TSN cycle times. For example, a 5G network supporting multiple critical services may have URLLC slices dedicated to the periodicity of the applications and their streams. For example, services that have applications operating at approximately 1 msec period may have a dedicated slice which operates at 1 msec cycle time. Similarly, services and applications operating at 100 msec period (or interval) may have a dedicated slice in the integrated TSN-5G system that operates at 100 msec cycle time. Such cycle-time slicing improves both the speed of configuration as well as the overall network performance. In some implementations, the TSN block 202 exposes the supported cycle time(s) for a given slice to its respective CM 215 though its ICI 406. The CMs 215 in turn may exchange with each other the supported cycle times for the TSN blocks under their management via inter-config module API 230 in order to create a configuration solution for the sliced TSN-5G system.

In some implementations, the solution or configuration data determined by a CM 215 may include, but is not limited to, a collective or set of configurations, timings, commands, controls, instructions, the like, or a combination thereof, for operating the respective TSN block 202 in accordance with the characteristics (e.g., as defined by the set of parameters) of the TSN block 202. In some aspects, the configuration data may include a specific transmission information for individual or collective (e.g. “global”) data frame transmission for one or more respective TSN blocks 202. The transmission information can include temporal information for the transmission of the data frame. In one or more aspects, the configuration data for a data frame can include a transmission start time. For example, the transmission start time can be the time at which the transmission of the data frame from the respective TSN block 202 initiates. In an aspect, the transmission of the data frame can be initiated by a selective opening of a gate of the respective TSN block 202 to transmit the data frame, as a data flow to a destination node (e.g., another TSN block 202). Conversely, the transmission of the data frame can be ceased or prevented by a selective closing of the gate of the respective TSN block 202 to transmit the data frame. The configuration data may also define or assign a specific path or link communicatively coupling the respective TSN block 202 and another node to transmit the data flow thereon. Additionally, the configuration data may define a duration of the transmission of the respective data flow from the respective TSN block 202. In an aspect, the duration of the data flow transmission can be defined by a time period between the selective opening of the gate (i.e., to transmit the data frame) and the selective closing of the gate of the respective node (i.e., to cease transmission of the data frame to the destination node).

In a conventional TSN system, the TSN schedule is expressed as an absolute time offset in a periodic cycle at which a TSN block is instructed to transmit that data. However, that may be too restrictive for a 5G system 106 composed of components from multiple vendors. In some implementations, a deadline-based schedule is determined and provided with the configuration data by a CM 215. The deadline-based schedule may instruct the TSN block 202 to transmit the data of a configured data flow no later than a deadline (which is expressed in terms of absolute time in a periodic cycle). In some implementations, the delay budget based approach would instruct the TSN block to transmit the data frame of a configured data flow within a delay budget. As such, under the delay budget based approach, the TSN block 202 is required to send a data frame arriving at its ingress port within a certain duration to its egress port. Such a scheme would not require every TSN block 202 to be time synchronized. In some implementations in which the TSN block 202 is configured under a rate constraint, the TSN block 202 is configured to transmit the data frames of a given data flow in a manner that the average or peak transmission rate (in bits per second) does not exceed a configured value (per the configuration data from the CM 215).

In some 5G systems, TSN blocks may be a set of shared resources made available by network slicing based on service profiles bounding network latency, periodic cycle including but not limited to delay/budget. In such implementations, two level scheduling may exist where the 5GS TSN-AF may enable configuring the TSN blocks 202 as a shared resource in addition to slice level TSN scheduling. In either case, the configuration attributes such as resource identifier may identify the TSN blocks for the appropriate configuration. As an example, a service provider may have multiple service profiles with specific periodic cycles, and multiple tenants of the service provider may utilize the same TSN blocks as specified by the 5GS TSN-AF configuration and may perform TSN flow aggregation. In some implementations, a service provider may provide a set of non-shared TSN blocks where only a single layer of service profile may exist. Device specific operating/required resource sharing mode may be available to the CNC 112 through TSN-AF.

As an example implementation of the deadline/delay budget approach by a TSN block 202, when a data frame arrives at an ingress port of the TSN block 202, the TSN block 202 would note the arrival time of the data frame using its local clock. The TSN block 202 may then identify the frame as belonging to a configured data flow, and may then start a countdown timer equal to the configured delay budget for that data flow. Using the transmission module 408, the TSN block 202 may prioritize the transmissions of data with least amount of time left. If the timer of a packet expires before it is transmitted, that event is recorded as a missed transmission and be accounted in the monitoring metrics by the recording module 410.

In some implementations, with respect to scheduled transmissions between the TSN block 202-1 (corresponding to the UE 118) and the TSN block 202-2 (corresponding to the RAN 120) may involve “enhanced” allocation (assignment and transmission) of uplink and downlink transmissions between the UE 118 and the RAN 120 in order meet the schedule assigned by the CM 215-a to the TSN block 202-1 corresponding to the UE 118. In some implementations, the CM 215-a may take into account of UE 118 buffer status and radio conditions as reported by RAN 120 when instantiating the TSN schedule and may adjust or report the required change in requested schedule. In some other implementation, the CM 215-a may send a real-time feedback on the radio conditions as received from RAN 120 to a master CM, e.g., the CM 215-d. This feedback loop may support re-calculating the TSN schedule to meet the packet delay budget either at this specific TSN block or across the TSN blocks on a given end-to-end path.

In this implementation, the link quality may be monitored and the CM 215-a may continuously adjust the radio resources in the configuration data to meet the transmission schedule. Radio resources may include but not limited to a logical channel, transmission power, and UE specific slot duration. In some implementations, a static assignment of fixed/deterministic uplink and downlink slots for a given UE 118 may be made such that, e.g., all UEs connected to a given RAN slice are given a scheduled transmission slot. 5G native over-the-air scheduling may be used to determine if the transmission from the UE 118 will meet the transmission deadline. If not, the UE 118 may request elevated access to the RAN 120 to achieve the schedule transmission. In some implementations, the scheduling in the 5G system 106 for scheduled transmissions may be based on quantized/discrete set of cycle times, wherein the set includes at least a 100 msec admin cycle time. In accordance with the subject technology, the radio link between the UE (e.g., represented by TSN block 202-1) and RAN (e.g., represented by TSN block 202-2) may be sliced based on the cycle time. In some implementations, the uplink and downlink between TSN block 202-1 and TSN block 202-2 may have radio resources allocated to each network slice based on the cycle time of the slice. For example, a 1 msec cycle time slice would require radio resources (channels, airtime, etc.) capable of delivering data at the 1 msec rate.

In some implementations, 5G resource elements (e.g., frequency and time slots) may be scheduled such that they meet TSN flow latency requirements in addition to “standard” 5G scheduling traffic prioritization requirements. More specifically, 5G timeslots for a TSN flow may be allocated such they transmit the TSN flow's messages at both the proper cycle time offset (phase) and within the time limit (TSN window time) required by the TSN schedule. In this case, the 5G scheduler differs from a “traditional” TSN Ethernet port in that multiple messages may egress simultaneously if transmitted on different frequencies. In some aspects, under the presence of poor RF channel conditions, the 5G system 106 may send multiple copies of a messages over different frequencies in order to increase the probability of meeting the transmission schedule and/or deadline.

To achieve reliable data transmissions in the system 200, redundant flow paths may be implemented. Disaggregated TSN blocks 202 of the 5G system 106 allow handling error (delayed, dropped, or corrupted frames) in a better way. In some implementations, UE 118 may initiate two redundant disjoint PDU Sessions to UPF 122 for redundancy in which case 5GC may configure the NG-RAN for dual connectivity according to 3GPP 38.300. In some other implementations, FRER may be used between some TSN blocks 202, but not others. For example, redundant streams may be implemented over the air interface between the UE 118 (TSN block 202-1) and the RAN 120 (TSN block 202-2) and then combined at the RAN 120, and can be split again over the core network (TSN block 202-3, 202-4), if needed. As shown in FIG. 1, current redundancy requirement according to 3GPP 23.501 is maximally disjoint paths between the UE 118 and the UPF 122. However, in accordance with the subject technology, there is no need to establish redundant disjoint paths across the entire 5G system, and instead may be implemented for only a portion of the 5G system. For example, in case of the over-the-air interface between the UE 118 and the RAN 120, the redundancy requirement may specify that the two paths should be on different frequencies or different MIMO channels or different time slots. In some instances, the subject disclosure allows for flexible use of redundancy including but not limited to more than two data paths, merging and splitting of data flows between TSN blocks, and support of TSN blocks with varying degree of redundancy capabilities.

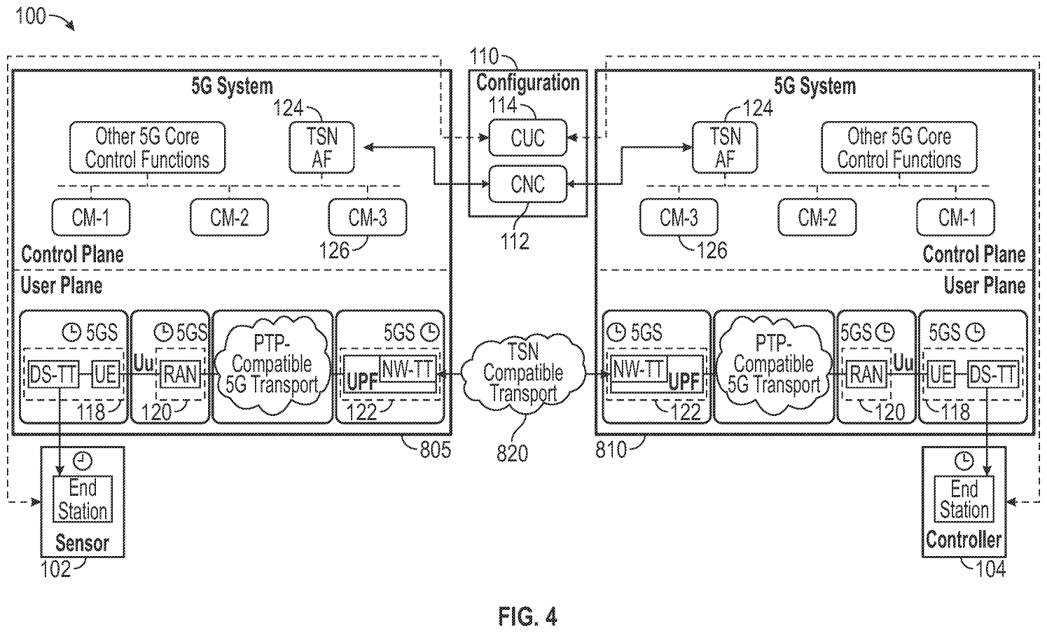

Referring to FIG. 4, an application data stream may span multiple integrated TSN-5G systems 805 and 810. In this case, TSN blocks may be geographically distributed interconnecting more than one 5G systems using a TSN compatible transport 820 including but not limited to a 5G backbone, private network tunnel or other wide area networks. In this subject invention, the TSN blocks are configured by their respective CMs 215. In some implementations, the configuration across the two TSN-5G systems 805, 810 may be coordinated through a centralized configuration utility (CNC) 112. In some other implementations, the CMs 215 between the two TSN-5G systems 805, 810 may communicate directly. In some implementations, multiple CUC's and CNC's may be used to capture the user requirements and generate TSN solutions and techniques provided in this disclosure (e.g., TSN Schedule, forwarding instruction, etc.).

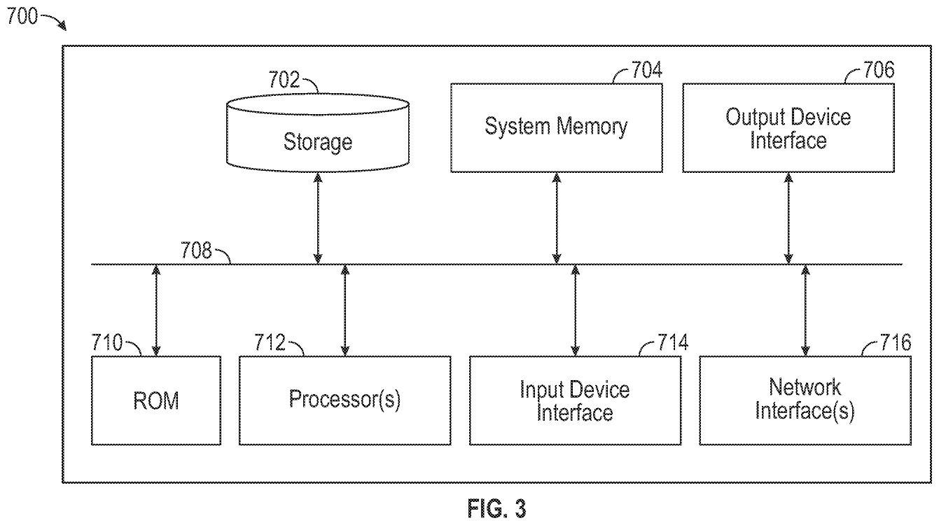

FIG. 3 illustrates an electronic system 700 with which one or more implementations of the subject technology may be implemented. The electronic system 700 can be, and/or can be a part of the TSN block 202 and/or the configuration module 215. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710 (which are each implemented as a non-transitory computer-readable medium). From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 3, the bus 708 also couples the electronic system 700 to one or more networks and/or to one or more network nodes through the one or more network interface(s) 716. In this manner, the electronic system 700 can be a part of a network of computers (such as a LAN, a wide area network (“WAN”), or an Intranet, or a network of networks, such as the Internet). Any or all components of the electronic system 700 can be used in conjunction with the subject disclosure.

In some embodiments, the TSN 5GS may implement IEEE 802.1Qbv standard. The 802.1Qbv TSN standard provides scheduled transmissions for safety-critical data frames in a predetermined manner, and is incorporated herein by reference in its entirety. A scheduler in accordance with the 802.1Qbv TSN standard may be referred to herein as a “TSN scheduler.” A TSN scheduler decides when TSN interfaces on each node are to send frames such that they reach their destination at the required time interval while also avoiding conflict with other time-sensitive frames along their paths. The TSN scheduler requires information about the topology and link speeds of the network as well as the required end-to-end latencies for each path to compute when to transmit frames. The IEEE 802.1Qbv standard also defines how the schedule is loaded onto TSN interfaces.

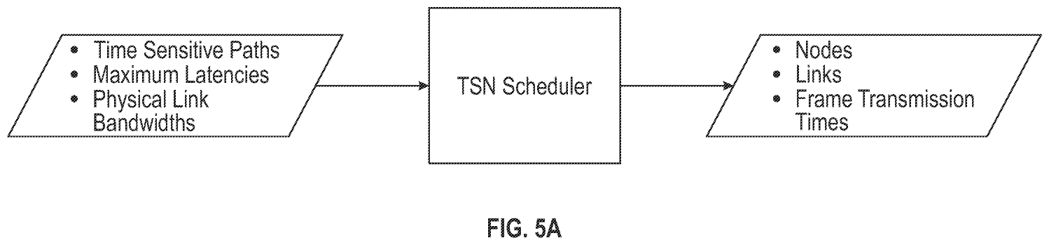

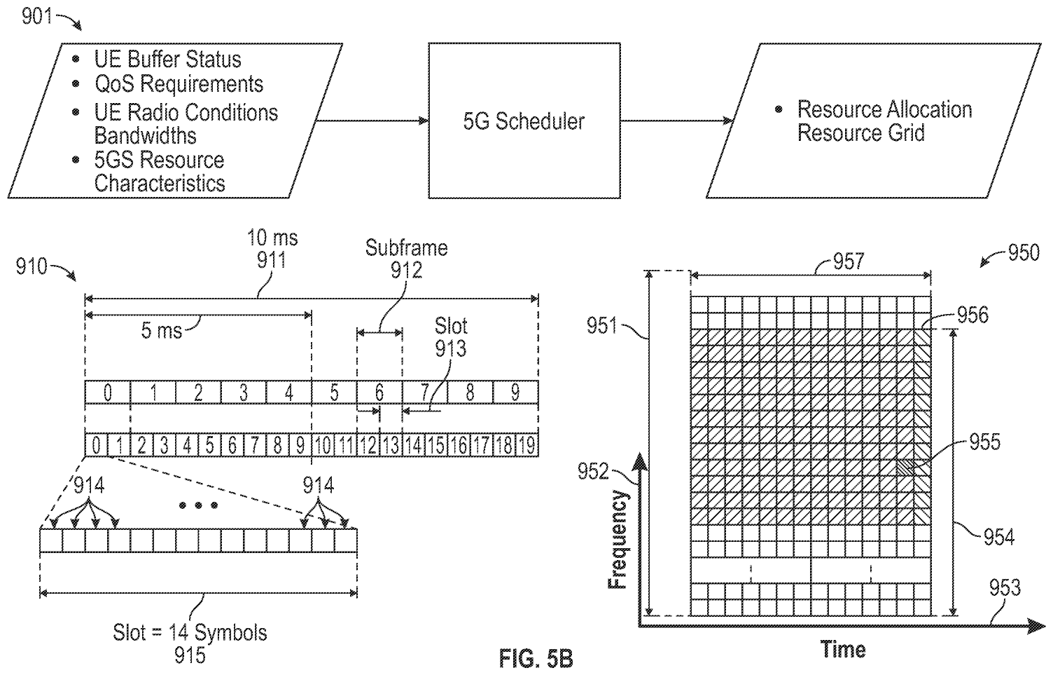

Turning now to FIG. 5A, a block diagram of the inputs and outputs of a TSN scheduler in accordance with one embodiment of the present disclosure is shown. The TSN scheduler 900 takes schedule input information 910, which may include a network description and link requirements, and returns schedule output information 920. Schedule input information may also include information relating to time sensitive paths through the network, and required end-to-end latencies, as well as physical link bandwidths. Schedule output information 920 may include nodes, links, and frame transmission times, to create a list of when each node's interface should transmit frames to achieve the required latencies without interference from other time-sensitive traffic.

The TSN scheduler must find gate open times for each virtual link, such that frames do not appear at the same output port at the same time. This requires knowledge of the network topology. Guaranteeing a minimum latency requires knowledge of frame size and the physical channel rate. The user is assumed to constrain the minimum rate by specifying the allowable cycle time during which a gate is open for each virtual link. The scheduler can shift cycle offsets based upon network topology and knowledge of other time-sensitive flows.

In some embodiments, a TSN schedule creation algorithm may begin with adjacency matrices representing paths through the network, and cycle times. A TSN schedule creation algorithm may output a matrix with feasible cycle offsets for each virtual link. Feasible cycle offsets are cycle time offsets for each virtual link such that frames do not appear at the same output port at the same time. A successful TSN schedule output will ensure that there is no overlap with adjacent virtual link cycles, which may be attained by sliding cycle times around on the virtual links.

Consider adjacency matrices A that describe the network topology with frame transmission time, V that describes paths with cycle lengths, and O that describes offsets for each cycle length. Assume each cycle time starts at time zero. Each element of O+A must be less than each element of V since the offset plus transmission time cannot be larger than a cycle. If any adjacent weights in O+A have starting and end times that overlap, then the corresponding Ethernet frames will interfere. Frame transmission start time for the network is described by O and frame transmission end time for the network is described by O+A. This implies that adjacent links must be checked such that O of one link occurs either before O of an adjacent link or after O+A of an adjacent link. However, propagation delay as a frame travels from one link to another must be considered. Thus, the previous offsets experienced by a frame need to be accumulated while noting that they could wrap around a cycle if the number of links traversed is long enough.

IEEE 802.1Qbv TSN scheduling standard also specifies how gates are configured that control output from queues on each port of each interface in the network. In some embodiments, up to eight queues may be used on a port that are programmed to open and close following a periodic schedule. The essence of IEEE 802.1Qbv scheduling is that the frame transmission from each queue, which is associated to a Traffic Class (TC), is scheduled relative to a known timescale. In order to achieve this, a transmission gate is associated to each queue, where the state of the transmission gate determines whether or not a queued frame can be selected for transmission. The transmission gate has two states: open and closed. A gate control list is associated with each port and contains an ordered list of gate operations. Each gate operation changes the transmission gate state for the transmission gate associated with each of the port's TC queues according to a scheduled time. The period of the time over which the sequence of gate operations in the gate control list repeats is called a “gating cycle.” IEEE 802.1Qbv specifies a list of parameters (e.g., a “Gate Parameter Table”) that supports the enhancement of scheduled traffic. In IEEE 802.1Qcc, centralized model, the Centralized Network Controller (CNC) calculates the gate operations based on the stream characteristics and configures the transmission gates on the ports of the TSN bridges accordingly.

In some embodiments, the TSN scheduler may be configured to perform scheduling at the egress port of the 5GS bridge, using output pacing with a de-jitter buffer function. 3GPP S2-1901150: “TSN QoS and traffic scheduling in 5GS.” A 5GS may be configured to convey the TSN traffic pattern and corresponding scheduling information from the CNC to the relevant nodes in 5GS. As used herein, a TSN traffic pattern may include information for TSN supporting such as gate control mechanism scheduling TSN traffic, etc. This part of information may be used as additional parameters for 5GS to fulfill the QoS requirement of TSN communications, which is not included in the 5G QoS model. 3GPP Technical Report (TR) 23.734 Solution #30 (see 3GPP TR 23.734 DRAFT V16.0.0+ (20198-102): “Study on 5GS Enhanced support of Vertical and LAN Services”).

A TSN schedule must determine the cycle time and configure each gate to open and close at the proper time within the cycle. In some embodiments, a TSN scheduler may be integrated into a larger set of programming tools, which may be used in sequence and which may also contain a data distribution service, an operating system, one or more task schedulers, or control systems, which, alone or in combination, may optimize when and where Ethernet frames should be sent and received and what type of Quality of Service (QOS) they require.

In some TSN networks, non-TSN traffic may also need to be routed. Although non-TSN traffic may not have the strict latency and delivery time requirements of TSN traffic, network performance and throughput for non-TSN traffic is also important. Non-TSN traffic may also be referred to as “best effort” traffic. In some embodiments, a TSN scheduler may also be used to transmit best effort traffic, e.g. during time that is not reserved for TSN traffic. While time sensitive traffic may take up reserved, periodic time slots that may be configured with different times at each node, unreserved time slots may remain available for best effort traffic.

In one or more embodiments, a TSN scheduler creates a set of constraints and solves for the solution that meets the constraints. In particular, the TSN scheduler may generate a schedule that fits the unscheduled communication data flows into the flow of the scheduled communications through the network. In one or more embodiments, the TSN scheduler may receive as input a destination for the data flow and an expected arrival time of that communication at the destination. The expected arrival time may be in the form of a maximum tolerable latency. Then, based on this information, the TSN scheduler may generate a schedule. In one or more embodiments, the schedule may include instructions about when to open and close one or more gates of one or more network queues to allow the transmission of the communication. In one or more embodiments, the TSN scheduler may solve the problem of enabling multiple flows of traffic to exist on a same Ethernet network such that Ethernet frames reach their destination at predetermined times, regardless of the topology of the network or the rates of flows of traffic running in the network. A TSN scheduler may perform mathematical analysis on the inputs it is given, using an algorithm, to create a feasible schedule. Inputs to the algorithm may relate to the topology of the network and the requirements of the TSN traffic in terms of time sensitivity, latency, and message size. In some embodiments, a TSN scheduler may work offline to generate a schedule, which may then be installed manually on the networking equipment that will implement the schedule. A process for generating a TSN schedule for opening and closing gates, based on schedule input information, is described in U.S. Pat. No. 11,121,978, which is incorporated by reference herein in its entirety.

Turning now to FIG. 5B, diagrams representing scheduling functionality of a 5GS in accordance with one embodiment of the present disclosure is shown.

Referring to 5G scheduler diagram 901, there is shown a scheduler in accordance with the above standard for 5GS that may be referred to herein as a “5G scheduler.” The 5G scheduler may include one or more dynamic resource schedulers that allocate physical layer resources for downlink and uplink. The 5G scheduler may take into account User Equipment (UE) buffer status, and Quality of Service (QOS) requirements (e.g., guaranteed (or non-guaranteed) bit rate, allocation and retention priority, reflective QoS attribute, maximum bit flow rate, and maximum packet loss rate). The 5G scheduler may assign resources by taking account radio conditions at the UE, which may be identified through measurements made at the radio and/or reported by the UE. The 5G scheduler decisions may be signaled by UEs identifying resources to be used by receiving a scheduling (resource assignment) channel.

The 5G scheduler may generate a schedule for one or more UEs of the 5GS based the one or more inputs described herein. In some embodiments, the 5G scheduler may generate a schedule that include carrier specific transmission time and reception times for components of the 5GS in at least one embodiment of the present disclosure. In some embodiments, the 5GS may include a multicarrier orthogonal frequency division multiplexing (OFDM) communication system that may include one or more carriers, for example, ranging from 1 to 32 carriers, in case of carrier aggregation, or ranging from 1 to 64 carriers, in case of dual connectivity. Different radio frame structures may be supported (e.g., for frequency division duplex (FDD) and for time division duplex (TDD) duplex mechanisms). Frame timing chart 910 shows an example frame timing according to at least one embodiment of the invention. Downlink and uplink transmissions may be organized into radio frames 911. In this example, radio frame duration is 10 ms. In this example, a 10 ms radio frame 911 may be divided into ten equally sized subframes 912 with 1 ms duration. Subframe(s) may comprise one or more slots (e.g. slots 913 and 915) depending on subcarrier spacing and/or CP length. For example, a subframe with 15 kHz, 30 kHz, 60 kHz, 120 kHz, 240 kHz and 480 kHz subcarrier spacing may comprise one, two, four, eight, sixteen and thirty-two slots, respectively. In frame timing chart 910 a subframe may be divided into two equally sized slots 913 with 0.5 ms duration. For example, 10 subframes may be available for downlink transmission and 10 subframes may be available for uplink transmissions in a 10 ms interval. Uplink and downlink transmissions may be separated in the frequency domain. Slot(s) may include a plurality of OFDM symbols 914. The number of OFDM symbols 604 in a slot 915 may depend on the cyclic prefix length. For example, a slot may be 14 OFDM symbols for the same subcarrier spacing of up to 480 kHz with normal CP. A slot may be 12 OFDM symbols for the same subcarrier spacing of 60 kHz with extended CP. A slot may contain downlink, uplink, or a downlink part and an uplink part and/or alike.

In some embodiments, the 5G scheduler may generate a schedule that include an OFDM resource grid for one or more subframes discussed above. An exemplary resource grid is shown at resource grid diagram 950. In an example, a carrier may have a transmission bandwidth 951. In one example, a resource grid may be in a structure of frequency domain 952 and time domain 953. In an example, a resource grid may comprise a first number of OFDM symbols in a subframe and a second number of resource blocks, starting from a common resource block indicated by higher-layer signaling (e.g. RRC signaling), for a transmission numerology and a carrier. In an example, in a resource grid, a resource unit identified by a subcarrier index and a symbol index may be a resource element 955. In an example, a subframe may comprise a first number of OFDM symbols 957 depending on a numerology associated with a carrier. For example, when a subcarrier spacing of a numerology of a carrier is 15 KHz, a subframe may have 14 OFDM symbols for a carrier. When a subcarrier spacing of a numerology is 30 KHz, a subframe may have 28 OFDM symbols. When a subcarrier spacing of a numerology is 60 Khz, a subframe may have 56 OFDM symbols, etc. In an example, a second number of resource blocks comprised in a resource grid of a carrier may depend on a bandwidth and a numerology of the carrier.

As shown at resource grid 950, a resource block 956 may comprise 12 subcarriers. In an example, multiple resource blocks may be grouped into a Resource Block Group (RBG) 954. In an example, a size of a RBG may depend on at least one of: a RRC message indicating a RBG size configuration; a size of a carrier bandwidth; or a size of a bandwidth part of a carrier. In an example, a carrier may comprise multiple bandwidth parts. A first bandwidth part of a carrier may have different frequency location and/or bandwidth from a second bandwidth part of the carrier.

With respect to downlink scheduling, the 5G radio can dynamically allocate resources to UEs via the Cell Radio Network Temporary Identifier (RNTI in general, C-RNTI for Cell RNTI) on one or more Physical Downlink Control Channels (PDCCH(s)). A UE may monitor the PDCCH(s) in order to find possible assignments when its downlink reception is enabled (activity governed by DRX when configured). When Carrier Aggregation (CA) is configured, the same C-RNTI applies to all serving cells.

The gNB may pre-empt an ongoing Physical Downlink Shared Channel (PDSCH) transmission to one UE with a latency-critical transmission to another UE. The gNB can configure UEs to monitor interrupted transmission indications using Interruption RNTI (INT-RNTI) on a PDCCH. If a UE receives the interrupted transmission indication, the UE may assume that no useful information to that UE was carried by the resource elements included in the indication, even if some of those resource elements were already scheduled to this UE.

With Semi-Persistent Scheduling (SPS), the gNB can allocate downlink resources for the initial Hybrid Automatic Repeat Request (HARQ) transmissions to UEs: Radio Resource Control (RRC) defines the periodicity of configured downlink assignments while PDCCH addressed to Configured Scheduling RNTI (CS-RNTI) can either signal and activate the configured downlink assignment, or deactivate it. That is to say, a PDCCH addressed to CS-RNTI indicates that the downlink assignment can be implicitly reused according to the periodicity defined by RRC, until deactivated. Retransmissions may be explicitly scheduled on PDCCH(s) if that is required.

Dynamically allocated downlink reception overrides a configured downlink assignment in the same serving cell, if they overlap in time. If not, a downlink reception according to the configured downlink assignment is assumed, if activated. UE may be configured with up to 8 active configured downlink assignments for a given Bandwidth Part (BWP) of a serving cell. When more than one is configured, the network decides which configured downlink assignments are active at a time, which may be all of them. When more than one downlink assignment is configured, each configured downlink assignment is activated separately using a Downlink Control Information (DCI) command and deactivation of configured downlink assignments is done using a DCI command, which can either deactivate a single configured downlink assignment or multiple configured downlink assignments jointly.

With respect to uplink scheduling, the gNB can dynamically allocate resources to UEs via the C-RNTI on PDCCH(s). A UE always monitors the PDCCH(s) in order to find possible grants for uplink transmission when its downlink reception is enabled (activity governed by Discontinuous Reception (DRX) when configured). When CA is configured, the same C-RNTI applies to all serving cells.

The gNB may cancel a Physical Uplink Shared Channel (PUSCH) transmission, or a repetition of a PUSCH transmission, or a Sounding Reference Signal (SRS) transmission of a UE for another UE with a latency-critical transmission. The gNB can configure UEs to monitor cancelled transmission indications using Cancelation RNTI (CI-RNTI) on a PDCCH. If a UE receives the cancelled transmission indication, the UE shall cancel the PUSCH transmission from the earliest symbol overlapped with the resource or the SRS transmission overlapped with the resource indicated by cancellation.

With Configured Grants, the gNB can allocate uplink resources for the initial HARQ transmissions and HARQ retransmissions to UEs. In one type of configured uplink grant (Type 1), RRC directly provides the configured uplink grant (including the periodicity). In a second type of configured uplink grant (Type 2), RRC defines the periodicity of the configured uplink grant while PDCCH addressed to CS-RNTI can either signal and activate the configured uplink grant, or deactivate it. In other words, a PDCCH addressed to CS-RNTI indicates that the uplink grant can be implicitly reused according to the periodicity defined by RRC, until deactivated. If the UE is not configured with enhanced intra-UE overlapping resources prioritization, the dynamically allocated uplink transmission overrides the configured uplink grant in the same serving cell, if they overlap in time. If they do not overlap in time, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels that have data to be transmitted and which are multiplexed or can be multiplexed in MAC PDUs associated with the overlapping resources. Similarly, in case a configured uplink grant transmissions or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB to schedule a retransmission. The UE may also be configured by the gNB to transmit the stored MAC PDU as a new transmission using a subsequent resource of the same configured uplink grant configuration when an explicit retransmission grant is not provided by the gNB.

Retransmissions other than repetitions may be explicitly allocated via PDCCH(s) or via configuration of a retransmission timer. The UE may be configured with up to 12 active configured uplink grants for a given BWP of a serving cell. When more than one is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When SUL is configured, the network should ensure that an active configured uplink grant on SUL does not overlap in time with another active configured uplink grant on the other UL configuration. For both dynamic grant and configured grant, for a transport block, two or more repetitions can be in one slot, or across slot boundary in consecutive available slots with each repetition in one slot. For both dynamic grant and configured grant Type 2, the number of repetitions can be also dynamically indicated in the L1 signaling. The dynamically indicated number of repetitions shall override the RRC configured number of repetitions, if both are present.

A 5G scheduler may include measurement reports required to enable the scheduler to operate in both uplink and downlink. These measurement reports may include transport volume and measurements of a UEs radio environment. Uplink buffer status reports (BSR) may be used to provide support for QoS-aware packet scheduling. In NR, uplink buffer status reports may refer to the data that is buffered in for a group of logical channels (LCG) in the UE. Eight LCGs and two formats may be used for reporting in uplink. The formats may include a short format to report only one BSR (of one LCG), and a flexible long format to report several BSRs (up to all eight LCGs).

Uplink buffer status reports are transmitted using MAC signaling. When a BSR is triggered, which may occur when new data arrives in the transmission buffers of the UE, a Scheduling Request (SR) can be transmitted by the UE (e.g. when no resources are available to transmit the BSR). For Integrated access and backhaul (IAB), the Pre-emptive BSR can be configured on the backhaul links. The Pre-emptive BSR may be sent based on expected data rather than buffered data.

Power headroom reports (PHR) may also be generated. PHR measure the difference between the nominal UE maximum transmit power and the estimated power for uplink transmission. To allow network to detect UL power reduction, the PHR reports may also contain Power Management Maximum Power Reduction (P-MPR, see TS 38.101-2 [35]) information that UE uses to ensure UE compliance with the Maximum Permissible Exposure (MPE) exposure regulation for FR2, which is set for limiting RF exposure on human body. Power headroom reports are transmitted using MAC signalling.

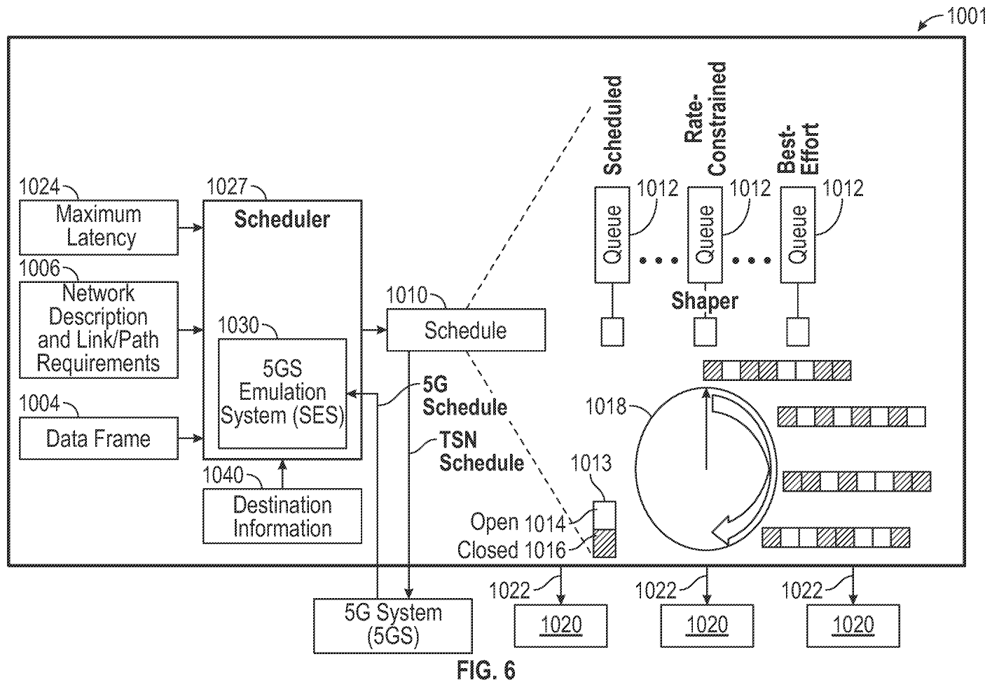

Turning now to FIG. 6, a block diagram of a TSN communication system including a scheduler and a corresponding 5GS network are shown. In one or more embodiments, the network may include a plurality of destinations 1020 or nodes, including the 5GS. The nodes may be connected to the communication system via one or more communication paths 1022 or links. The communication links 1022 may be connected to each other via ports and/or switches 1020. In one or more embodiments, two or more data frame transmission paths or flows may overlap. Data frames 1004 may collide where these transmission paths overlap, and collisions may result in the frames being dropped and not delivered to their respective destinations 1020. As such, a TSN scheduler 1027 may fit unscheduled/best effort frames into a schedule 1010 with scheduled frames, so that the data frames 1004 do not collide and instead reach the appropriate destination at an appropriate time.

In one or more embodiments, the TSN network may include a plurality of queues 1012 (e.g., Queue 0, 1, 2, 3, 4 . . . 7, etc.) for transmitting the data frames 1004 to their respective destinations 1020. In one or more embodiments, the queues may exist in all interfaces-both on the end-system (e.g., device) and in each port (connection) of the switch 1001. In one or more embodiments, each queue 1012 may include a gate 1013 that may be in an open position 1014 or a closed position 1016, and may only allow transmission of the data frame 1004 when in the open position 1014. In one or more embodiments, the operation of the queue gates may be synchronized to a same clock 1018. Of note, the synchronization is important, especially for high priority traffic, to make sure the gates are closed at precisely the right time to avoid collision and to get the data frame through the network per the schedule 1010. In one or more embodiments, the scheduler 1027 executes calculations, based on the received input, to determine the openings/closing gate times along the path of the flow to meet the destination 1020 and arrival times (e.g., within the maximum latency), as specified by the application. In one or more embodiments, the content of the schedule 1010 specifies gate openings/closings along the path of a flow, as described in the TSN standard.

In one or more embodiments, TSN scheduler 1027, located at the switch 1001 receives input from at least one application to create the schedule 1010. While FIG. 6 shows the scheduler 1027 located the switch 1001, the TSN scheduler 1027 may reside anywhere within the network. In one or more embodiments, the TSN scheduler 1027 may communicate with all switches and end systems to configure them. The input may include at least one of one or more data packets made of one or more data frames 1004, the destination 1040 of the data frames, and the maximum latencies 1024. The TSN scheduler 1207 may receive other suitable input. For example, the TSN scheduler 1027 may also receive a network topology description and path or link requirements 1006 (e.g., an indication of time sensitive paths, physical link bandwidths, size of frames (“payload”)) from an application 113 and/or toolchain, or any other suitable source. The scheduler 1027 may then generate a schedule 1010 for communication traffic through the network.

A TSN scheduler as described herein, and the 802.1Qbv TSN standard, relates generally to ethernet traffic. A TSN scheduler may in some instances be implemented in a 5GS on a 5G gNB radio, for example. 3GPP TS 38.300 version 16.4.0 Release 16 Section 10 is a standard that describes scheduling performed by the 5G gNB radio to optimize network throughput therein, and is incorporated by reference herein in its entirety.

A TSN scheduler and a 5G scheduler may work in tandem on the same network, wherein the 5G scheduler may use information from the TSN scheduler to inform its scheduling process. In some embodiments, this information may include exact arrival times at different nodes for TSN messages, and message sizes. TSN scheduling information may also be included in the radio conditions at the UE, which may be reported by the UE to the 5G scheduler. As discussed above, the TSN scheduler outputs a list of when each node's interface should transmit frames to achieve the required latencies without interference from other time-sensitive traffic. The schedule data may also include frame size, priority level, packet delay budget, and packet error rate. Knowledge of TSN scheduling elements may be used in measurement reports, and/or in BSRs, which presence may enable the 5G scheduler to allocate resources more efficiently.

As discussed above, the 5G schedule takes as inputs the UE buffer status and QoS requirements of each UE and associated radio bearers, and assign radio resources (e.g. resource blocks) between UEs. 5G schedulers may also assign resources in accordance with radio conditions at the UE, which may be identified through measurements made at the gNB radio and/or reported by the UE. A 5G scheduler may generate the 5G schedule based on arrival times of TSN frames in its schedule. The presences of these arrival times, already in the schedule before the rest of traffic is scheduled, without having to be scheduled by the 5G scheduler, may free up the 5G scheduler process to more efficiently schedule best effort frames in the remaining available time slots after TSN frames have already been scheduled. The presence of equipment needed to support the throughput required for on time TSN delivery may then also be used to increase the delivery speed of non-TSN frames that are scheduled alongside.

While ordinary “best effort” traffic may have some associated QoS information a 5G schedule that is in possession of the more specific information that are delivered from the TSN scheduler will enhance the ability of the scheduler to allocate radio resources and resource blocks to best effort traffic, as the TSN scheduler will inform the 5G scheduler about when gates will be opened and closed for transmission. The 5G scheduler may then be able to use the gate status information to route other traffic to other gates for more efficient delivery. More specially, the 5G scheduler will allocate resource blocks and elements such that messages and frequencies will be partitioned in such a manner to satisfy the TSN flow requirements specified in the TSN schedule.

Knowledge of TSN scheduling information could also play a role in optimizing multiple-input/multiple-out (MIMO) antenna operation, which is at lower physical level than the gNB scheduler. In other words, different antenna configurations may be implemented based on the TSN schedule. For example, more antennas may be dedicated to high-priority TSN flows than lower priority TSN flows. In addition, or alternatively, when higher priority TSN flows are transmitting over the network, one or more antennas having higher signal transmission capability may be selected over antennas with lower signal transmission capability, and vice versa.

Output from the 5G scheduler may also be useful information to the TSN scheduler to update the TSN schedule. 5G scheduling information may include buffer status reports (BSR), which measure data that is buffered in a logical channel queue in UE. These reports may be helpful as part of the physical link bandwidth information that is input to the TSN scheduler. The 5G scheduler's power headroom reports (PHR) may also provide transmission power information about UEs that may inform the TSN scheduler's schedule input information about physical link bandwidths. 5G scheduling information may include QoS flow characteristics defined in 3GPP TS 23.501 Table 5.7.4-1 Standardized 5QI to QoS characteristics mapping (incorporated herein by reference in its entirety). QOS flow characteristics may include resource type, default priority level, packet delay budget, packet error rate, default maximum data burst volume and/or default averaging window. Because the 5G scheduler may be optimized to meet traffic classes as specified in 23.501-Table 5.7.4-1: Standardized 5QI to QoS characteristics mapping categories, in some embodiments, the wired TSN scheduler may be adapted to use the aforementioned class latencies and jitter when creating scheduled paths over 5GS.

Referring to FIG. 6, in some embodiments, TSN scheduler 1027 may include a 5GS emulation system (SES) 1030. The SES 1030 may be a “digital twin” of the 5GS or components thereof including one or more of: devices, traffic, base stations, RF channels, network slice information, MEC operating characteristics, and user data, among others. For example, the SES 1030 may be a virtual representation of the 5GS that spans the lifecycle of the 5GS, is updated from real-time data, and uses simulation, machine learning and reasoning to help decision-making. The SES 1030 may evolve synchronously with the 5GS throughout the entire life cycle of the 5GS. In some embodiments, SES 1030 may receive network configuration and operation data of the 5GS (or components thereof). The SES 1030 may utilize such network configuration and operation data (including network load data and network slice data) to emulate the 5GS and provide predictive information of the 5GS to facilitate generation of the TSN schedule by the TSN scheduler 1027 in addition to the other input factors mentioned herein for generating the TSN schedule.

Integrated TSN-5G scheduling may in some aspects be implemented using a distributed algorithm and system for TSN scheduling across domains. In an integrated TSN-5G environment, a 5GS may be viewed as a single bridge for TSN scheduling. If the 5GS were a real bridge, this would add to latency, because TSN flows would have to pass through a switching fabric on its way to bridge output queues. However, a 5GS avoids such switching fabric delays by scheduling across non-interfering time and frequency Resource Blocks. Accordingly, a wireless, self-configuring TSN scheduler mechanism may be constructed using 5GS schedule feedback. A 5G bi-directional scheduling status information message would allow an improved model of a 5G virtual bridge to be built into a TSN scheduler. Information that is already part of the 5G standard may be used to inform the TSN scheduler to create schedules that operate with better performance with the 5GS.

Joint or integrated TSN-5G scheduling may be achieved, in one aspect of the present disclosure, via distributed scheduling. Accordingly, the present disclosure relates to a 5G bidirectional scheduling status information message. The message may contain anticipated TSN User Equipment (UE) configuration from the TSN application scheduler and may return 5G scheduler information such as that found in the System Information Block (SIB) scheduling information. More information about SIB scheduling information may be found in 3GPP TS 38.331 version 15.5.1 Release 15 (“5G, NR, Radio Resource Control (RRC), Protocol specification”), which is incorporated herein by reference in its entirety.

The desired scheduling improvement, with bi-directional scheduling status information passing between the 5G Scheduler and the TSN scheduler, may be achieved via a distributed scheduling algorithm. This would allow multiple TSN schedulers to function at the same time, divided by domain, so that they may inform each other's scheduling data as well as the scheduling data of the 5GS.

At a higher level, multiple TSN schedulers may be used, such that each scheduler may cover distinct domains. However the distinct domains are interconnected. The domains can be divided according to different criteria, and more than one criterion may be used. Domains may be separated by space. Separating domains by space may be the easiest criterion to implement, as each device along the network may be its own domain, or may be grouped with devices that have similarities such as proximity in space. When domains are partitioned by space, scheduling domains with common links may be treated as peers.

Domains may also be partitioned by network flow, which may more specifically include partitioning by network slice. Network slicing is a virtualization concept that allows a physical network to be divided, virtually, into different networks that may emphasize different features or allocate resources differently, in accordance with different use cases or needs of the network. For example, the same physical, e.g., 5G wireless, network, may have a need for a network that prioritizes high speed, and a need for another network that prioritizes low latency, and a third that has specific requirements for Quality of Service (QOS). The network may accordingly be divided, virtually, into slices that allocate resources to suit both of those needs. A distributed TSN scheduler may create allocate a different TSN scheduler for each network slice.

Domains may also be partitioned by time. TSN scheduling is performed on the basis of time cycles, wherein, for example, each clock cycle allows time sensitive packets to be transmitted at one slice of the cycle, and best efforts or other lower time priority packets are transmitted later in the time cycle. In one embodiment, domains may be partitioned by subsets of cycle time. In one embodiment, domains may be partitioned by subsets of cycle time.

Persons having skill in the art will realize that other domains or domain classifications may be used. Accordingly, a 5GS, or a 5G Network, may be one or more domains in a distributed TSN scheduler in accordance with one aspect of the invention. In some embodiments, the TSN scheduling can interact with 5GS in many ways in accordance with 3GPP specifications (e.g., TS 23.501 section 5.27.2 TSC Assistance Information (TSCAI) and TSC Assistance Container (TSCAC), TS 23.501 section 5.7.3.4 Packet Delay Budget) and TSN specifications (e.g., 8.6.8.4 of IEEE 802.1Q). 3GPP specifications and TSN specifications are incorporated herein by reference in their entirety. In some embodiments, the distributed TSN scheduler (e.g., CNC) provides TSN scheduling information (e.g., TSN Qbv gate control list as specified in 8.6.8.4. of IEEE 802.1Q) to the TSN AF 124. The TSN AF 124 may interact with the 5G scheduler (independent of the TSN scheduler) to find a feasible allocation of 5G Resource Blocks and frequencies.

Each TSN scheduler in the set of distributed TSN schedulers, for each domain, may be configured to repeatedly compute schedules and exchange information with peers. This iterative process may be repeated until a global feasible schedule is achieved, that meets the requirements of the network in terms of speed, latency, QoS, or other requirements. In one or more embodiments, each domain may have different schedules, including different cycle times, and scheduling may operate independently within each domain. A local feasible solution is one that satisfies all constraints and requirements within the local region of domain (a subset of the entire network). A global feasible solution is one that satisfies all constraints and requirements for all local regions or domains in the network.

Some domains may be configured as “transit domains.” TSN streams may pass into or though transit domains on their way to a TSN Listener device. In some aspects of the disclosure, virtual streams may be created to indicate specific slack scheduling capacity. Transit information for a TSN stream may include message size and maximum latency. Transit information may be shared across and among domains. In some aspects, all transit information may be shared among domains.

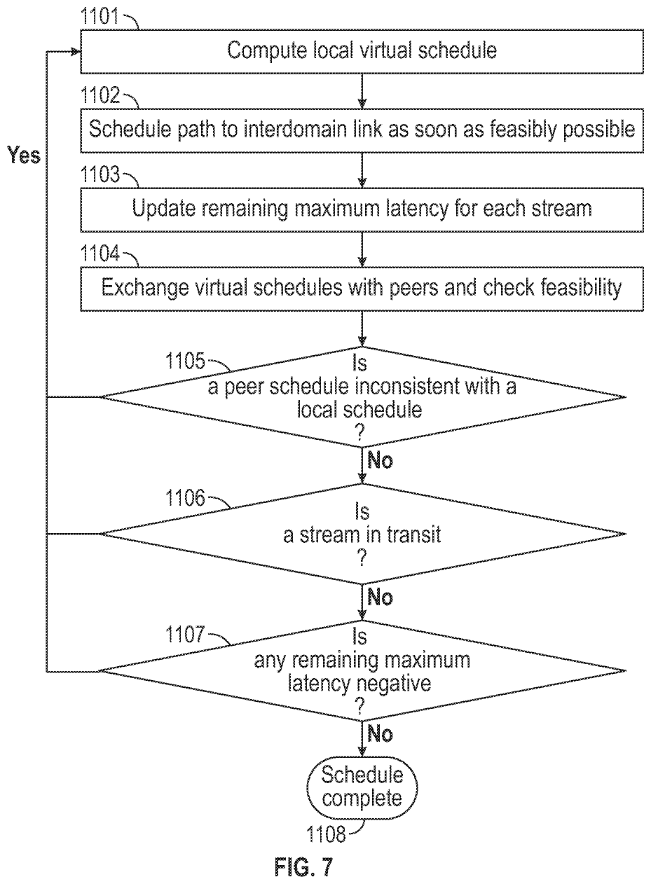

Turning now to FIG. 7, an exemplary algorithm is shown in accordance with one aspect of the present disclosure. Within each domain, local virtual schedules may be computed (1101). A virtual schedule is a TSN schedule that is held in memory and has not yet been downloaded on to network devices to configure them. It is a TSN schedule that is under consideration and subject to change as the algorithm proceeds. For non-transit streams, computing a local virtual schedule may include scheduling (1102) a path to an interdomain link as soon as feasibly possible. For transit streams, a latency may be set to the negative of the maximum latency reported from a peer domain or multiple peer domains. When the stream arrives at the interdomain, the remaining maximum latency for the stream may then be updated (1103). In some embodiments, if desired, virtual streams may be included in the schedule and denoted or indicated that they are virtual by an indicator. Some uses of virtual streams may include in anticipation of transit streams, or to reduce the likelihood that the current domain will have to be rescheduled during the distributed scheduling process.

A distributed scheduling algorithm may continue with TSN domains exchanging (1104) virtual schedules with peers and checking for feasibility. If a peer schedule is inconsistent with a local schedule (1105), then the peer may be asked to compute (1101) the local virtual schedule again. After which, the exchange (1104) of virtual schedules with peers may be repeated. The exchange (1104) of virtual schedules may also need to be repeated if any stream is in transit (1106). If the event any remaining maximum latency is negative (1107), in other words if the exchanged virtual schedules would result in the packet not meeting its latency requirements, then this deficiency in the schedule may be reported to the peer that generated the schedule, and the computation (1101), scheduling (1102), updating (1103) and exchange (1104) of virtual schedules may be repeated. If the feasible schedule is obtained using only peer virtual streams, then there is no need to repeat the exchange of virtual schedules, and the schedule is complete (1108).

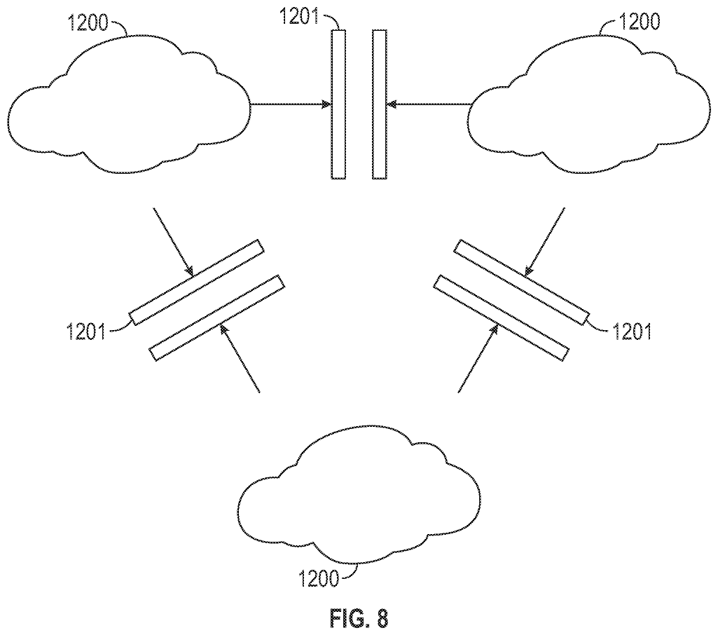

Turning now to FIG. 8, a block diagram of an exchange of schedules among three domains 1200 is shown. Persons having skill in the art would realize that three is an exemplary number of domains 1200 for illustration purposes, and more domains may be used. As discussed above, intradomain schedules would be completed, including transit streams, if feasible, and are then shared to create interdomain schedules. Interdomain streams may have potential excessive delays 1201, which may exceed their maximum latency. In such instances, rescheduling may be required to reduce interdomain stream delays. This may be accomplished using a binary search type of algorithm to search for feasible interdomain stream solutions. To distribute the load and difficulty of creating a feasible schedule, across the domains, each domain may in some embodiments attempt to reduce latency by half the excess. In other embodiments, domains may adjust propositional to their excess schedule capacity.

In some embodiments, TSN domains may form a network wherein the vertices of the network are domains and edges of the network are interdomain links. In other embodiments, the network topology may form a tree, as in a hierarchical topology, or a cyclic topology may be used. In a cyclic topology, cycles in the TSN domain network could result in an endless set of rollbacks. In a hierarchical topology, a tree structure may allow composition of schedules from children. Accordingly, a hierarchical topology with a tree structure may be preferable. In some aspects, the tree may be a spanning tree.

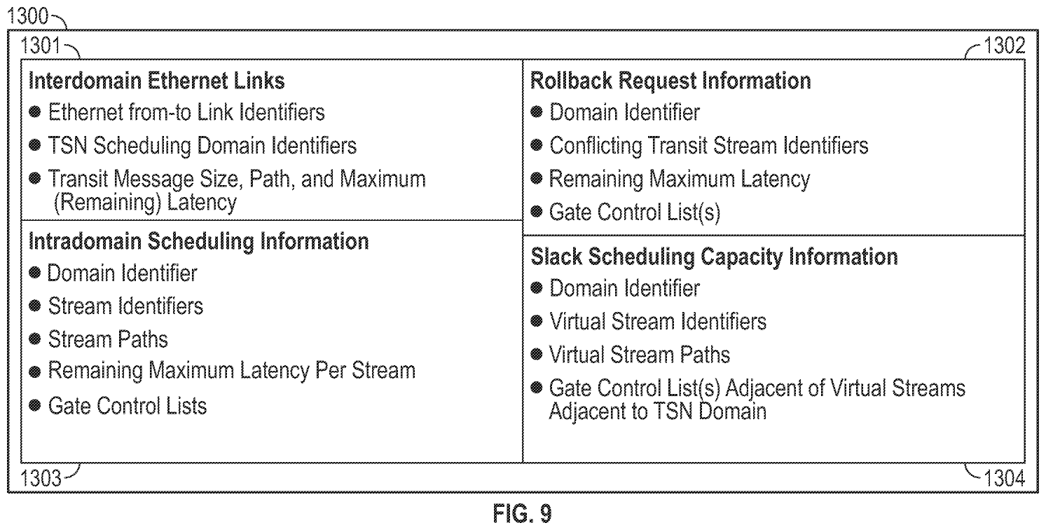

As part of this algorithm, distributed scheduler messages may be created. FIG. 9 contains an exemplary distributed scheduler message 1300 in accordance with one embodiment of the present disclosure. Distributed scheduler message fields may contain interdomain ethernet links 1301. Interdomain ethernet links 1301 may be used to identify ethernet links in current domain that connect to an adjacent domain. Message fields containing interdomain ethernet links 1301 may also be used to propagate transit stream scheduling input into other domains. Message fields to convey interdomain ethernet link information 1301 may include ethernet from and to link identifiers, scheduling domain identifiers, and transit details. Transit details may include message size, path, and maximum and/or maximum remaining latency.

Distributed scheduler message 1300 may also contain intradomain scheduling information 1302. Intradomain scheduling information 1302 may contain information in related fields, that may include a domain identifier, one or more stream identifiers, data identifying a stream path through the network, total and/or remaining maximum remaining latency per stream, and gate control lists. Remaining maximum latency may be calculated to be below zero of maximum latency requirements are not met. If transit of the stream is successfully scheduled within the domain, maximum remaining latency may be zero or above zero. Intradomain schedule fields 1302 may be used to define the domain's TSN schedule. Intradomain scheduling information 1302 may include intradomain schedules for transit streams, which may trigger a need for adjustment to the intradomain schedule.

Distributed scheduler message 1300 may also contain rollback request information 1303. A rollback request may be sent from a first domain to a second domain, wherein the first domain is requesting that the second domain recompute its schedule to accommodate a transit stream conflict. Rollback request information 1303 may include rollback request fields, which may include a domain identifier, identifiers of conflicting transit streams, and maximum and/or maximum remaining latency. Rollback request information 1303 may include one or more gate control lists for gates that are adjacent to one or more conflicting domains that schedule conflicting streams.

Distributed scheduler message 1300 may also contain slack scheduling capacity information 1304. Slack scheduling capacity information 1304 may be used to inform an adjacent domain that scheduling capacity has specific slack capacity available. Slack capacity in this context may refer to specific capacity within which flows may be scheduled that will not conflict with the current schedule. Slack scheduling capacity information 1304 may include fields that include domain identifier information, virtual stream identifier information, virtual stream path information, and one or more gate control lists. A gat control list may include a list of virtual streams adjacent to the TSN domain.

In some embodiments of this disclosure, a communication network configured to support time-sensitive deterministic communication based on a time-sensitive network (TSN) mechanism is provided. The communication network may include a plurality of network domains in the communication network connecting each other; and a plurality of schedulers in the plurality of network domains. A respective of the plurality of schedulers may be configured to compute a local schedule for a respective of the plurality of network domains, and a first scheduler and a second scheduler of the plurality of schedulers configured to iteratively exchange a first local schedule and a second local schedule.

The first local schedule and the second local schedule may include different cycle times. The first network domain transmits interdomain ethernet link information related to a link connecting the first network domain and the second network domain, and intradomain schedule information related to the first local schedule. The intradomain schedule information may include a stream identifier and a remaining maximum latency per a stream identified by the stream identifier.

The second local scheduler may be configured to determine whether the first local schedule is consistent with the second local schedule based on the received first distributed message; and in response to a determination that the first local schedule is not consistent with the second local schedule, send a second distributed message including a request for recomputing the first local schedule to the first local scheduler. In response to at least one transit stream passing into the second network domain, the second local scheduler may be configured to determine that the first local schedule is not consistent with the second local schedule. The request for recomputing the first local schedule to the first local scheduler may include a conflict transit stream identifier for identifying each of at least one transit stream passing into the second network domain. Further, in response to the remaining maximum latency per a stream which has a value smaller than zero (0), the second local scheduler may be configured to determine that the first local schedule is not consistent with the second local schedule.

The first distributed message may include slack scheduling capacity information related to one or more virtual streams which are scheduled according to the first local schedule. At least some of the domains in the plurality of domains are separated by space, network flow, network slice, and/or time.

In some embodiments, a method of generating a schedule for transmission of streams in a communication network configured to support time-sensitive deterministic communication based on a time-sensitive network (TSN) mechanism is provided. The method may include computing a first local schedule for the first network domain at the first network domain of a plurality of network domains in the communication network connecting each other; computing a second local schedule for the second network domain at the second network domain of a plurality of network domains; and iteratively exchanging the first local schedule and the second local schedule between the first network domain and the second network domain.

The method may further include, at the second network domain, receiving a first distributed message including interdomain ethernet link information related to a link connecting the first network domain the second network domain and intradomain schedule information related to the first local schedule, determining whether the first local schedule is consistent with the second local schedule based on the received first distributed message; and in response to a determination that the first local schedule is not consistent with the second local schedule, send a second distributed message including a request for recomputing the first local schedule to the first local scheduler. The intradomain schedule information may include a stream identifier and a remaining maximum latency per a stream identified by the stream identifier.

Determining whether the first local schedule is consistent with the second local schedule based on the received first distributed message may include determining whether at least one transit stream passes into the second network domain. In response to a determination that at least one transit stream passes into the second network domain, the request for recomputing the first local schedule may include a conflict transit stream identifier for identifying each of at least one transit stream passing into the second network domain. Determining whether the first local schedule is consistent with the second local schedule based on the received first distributed message may include determining whether a remaining maximum latency per a stream in the received first distributed message has a value smaller than zero (0).

The first distributed message further includes: slack scheduling capacity information related to one or more virtual streams which are scheduled according to the first local schedule.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks. The functions disclosed herein may be implemented using quantum computing, pulse-coupled oscillation (PCO)/Ising computing.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

1. A system configured to optimize network resource allocation of a communication network based on a time-sensitive network (TSN) mechanism, comprising:
a first scheduler configured to: generate scheduling information to allocate network resources for data transmissions between network components in the communication network, the scheduling information including Quality of Service (QOS) parameters for a User Equipment (UE) and availability information of the network resources of the communication network;
a second scheduler configured to:
generate a TSN schedule for the transmission of a TSN flow from a source device to a destination device in the communication network;
receive the scheduling information from the first scheduler; and
update the TSN schedule to be aligned with the allocation of the network resources based on the scheduling information,
wherein the first scheduler is further configured to update the scheduling information based on the updated TSN schedule to adjust allocation of the network resources to support the transmission of the TSN flow based on the updated scheduling information; and
a configuration module configured to manage the TSN flow from the source device to the destination device via at least one of the network components based on the updated TSN schedule and the updated scheduling information.

2. The system of claim 1, wherein the first scheduler configured to generate the scheduling information based on System Information Block (SIB) information including network configuration information.

3. The system of claim 1, wherein the first scheduler is configured to generate the scheduling information based on a buffer status of the UE and radio conditions at the UE.

4. The system of claim 1, wherein the second scheduler is configured to generate the TSN schedule based on time sensitive path information and maximum latency for the transmission of the TSN flow.

5. The system of claim 3,
wherein the scheduling information further includes the buffer status of the UE.

6. The system of claim 1,
wherein the network components include the UE and a Radio Access Network (RAN).

7. The system of claim 6, wherein the configuration module is configured to adjust allocations of uplink and downlink transmissions between the UE and the RAN based on the updated TSN schedule and the updated scheduling information.

8. The system of claim 7,
wherein the configuration module is configured to monitor a link quality between the UE and the RAN.

9. The system of claim 1, wherein the scheduling information includes available transmit power headroom of the UE.

10. The system of claim 1, wherein the first scheduler is configured to schedule Multi-Input Multi-Output (MIMO) operations of antennas to support the transmission of the TSN flow based on the updated TSN schedule.

11. The system of claim 1, wherein the second scheduler includes a communication network emulator associated with the communication network, the communication network emulator is configured to: receive network configuration and operation data of the communication network from the communication network and provide predictive information of the communication network.

12. The system of 1, wherein the second scheduler is distributed in to a plurality of local schedulers in a plurality of network domains in the communication network connecting each other, a respective of the plurality of local schedulers configured to compute a local schedule for a respective of the plurality of network domains, a first local scheduler and a second local scheduler of the plurality of local schedulers configured to iteratively exchange a first local schedule and a second local schedule.

13. The system of claim 12, wherein the first local schedule and the second local schedule include different cycle times.

14. A method of optimizing network resource allocation of a communication network based on a time-sensitive network (TSN) mechanism, the method comprising:
generating scheduling information to allocate network resources for data transmissions between network components in the communication network, the scheduling information including Quality of Service (QOS) parameters for a User Equipment (UE) and availability information of the network resources of the communication network;
receiving a TSN schedule for the transmission of a TSN flow from a source device to a destination device in the communication network which is updated to be aligned with available network resources based on the scheduling information;
updating the scheduling information based on the updated TSN schedule to adjust allocation of the network resources to support the transmission of the TSN based on the updated scheduling information; and
managing the data transmissions of the TSN flow from the source device to the destination device via the network components based on the updated TSN schedule and the updated scheduling information.

15. The method of claim 14,
wherein generating the scheduling information based on a buffer status of the UE and radio conditions at the UE.

16. The method of claim 14, wherein the scheduling information includes a buffer status of the UE.

17. The method of claim 14,
wherein the network components include the UE and a Radio Access Network (RAN), managing the data transmissions of the TSN flow from the source device to the destination device via the network components further includes: adjusting allocations of uplink and downlink transmissions between the UE and the RAN based on the updated TSN schedule and the updated scheduling information.

18. The method of claim 14,
wherein the scheduling information includes available transmit power headroom of the UE.

19. The method of claim 14,
wherein the TSN schedule is generated by:
computing a first local schedule for a first network domain at the first network domain of a plurality of network domains in the communication network connecting each other;
computing a second local schedule for a second network domain at the second network domain of a plurality of network domains; and
iteratively exchanging the first local schedule and the second local schedule between the first network domain and the second network domain.

20. The method of claim 19, wherein the first local schedule and the second local schedule include different cycle times.
